(19) United States
(12) Patent Application Publication
(10) Pub. No.: US 2011/0255525 A1
(43) Pub. Date: Oct. 20, 2011

(54) Apparatus and Method to Provision Access Point Credentials into Mobile Stations

(76) Inventors: Mark Powell, San Jose, CA (US); Michael A. Raffel, Redmond, WA (US); Dave M. Singhai, San Jose, CA (US)

(21) Appl. No.: 13/084,526

(22) Filed: Apr. 11, 2011

Related U.S. Application Data
(62) Division of application No. 11/669,153, filed on Jan. 30, 2007, now abandoned.
(60) Provisional application No. 60/763,818, filed on Jan. 30, 2006.

(51) Int. Cl. H04W 12/08; H04W 4/14

(52) U.S. Cl. 370/338

(57) ABSTRACT

Some embodiments provide a method that sends information about a wireless communication system access point to a server. The method receives the access point information at the mobile station from the server. The method enables the mobile station to access the wireless communication system through the access point by using the access point information. In some embodiments, the access point information is sent from the server to the mobile station using a short message service (SMS) message. In some embodiments, the access point information includes the SSID and the MAC ID of the access point.

### CLAIM OF BENEFIT TO RELATED APPLICATIONS

This application claims the benefit of U.S. Provisional Application 60/763,818, entitled “Short Message Based Management and Configuration for an Integrated Wireless System,” filed Jan. 30, 2006, which is herein incorporated by reference.

### FIELD OF THE INVENTION

The invention relates to telecommunication. More particularly, this invention relates to provisioning, management, and configuration of mobile stations and access points in an unlicensed wireless communication system.

### BACKGROUND OF THE INVENTION

Many mobile devices such as mobile phones, laptops, personal digital assistants (PDAs), etc, include wireless IP Access such as WiFi. Using private WiFi access points requires the mobile device to be preprogrammed with the access point credentials such as (Service Set Identifier) SSID and a security key such as a Wired Equivalent Privacy (WEP) or a Wireless Application Protocol (WAP) key.

Currently, there are no simple, automated ways to enable mobile stations and access points (APs) to get configured to connect to each other. Manually entering the AP credentials on a mobile station keyboard is very lengthy. It requires many more key presses than digits and characters and is prone to errors. Customers are often frustrated and would have a bad experience. Therefore, there is a need in the art for a system to automatically provision the access point credentials into a mobile station without requiring the user to enter lengthy keys.

### SUMMARY OF THE INVENTION

Some embodiments provide a method that sends information about a wireless communication system access point to a server. The method receives the access point information at the mobile station from the server. The method enables the mobile station to access the wireless communication system through the access point by using the access point information. In some embodiments, the access point information is sent from the server to the mobile station using a short message service (SMS) message. In some embodiments, the access point information includes the SSID and the MAC ID of the access point.

### BRIEF DESCRIPTION OF THE DRAWINGS

The novel features of the invention are set forth in the appended claims. However, for purpose of explanation, several embodiments of the invention are set forth in the following figures.

FIG. 1 illustrates a system that integrates a licensed wireless communication system and an unlicensed wireless communication system.

FIG. 2 illustrates different components of a system used to provision mobile stations in some embodiments.

FIG. 3 illustrates a process used to provision a mobile station in some embodiments.

FIG. 4 illustrates a system used to provision a user's first mobile station at point of sale in some embodiments.

FIG. 5 illustrates a process used to provision a user's first mobile station at point of sale in some embodiments.

FIG. 6 illustrates a system used to provision a user's first mobile station in some embodiments.

FIG. 7 illustrates a process used to provision a user's first mobile station in some embodiments.

FIG. 8 illustrates a system used to provision a mobile station using the access point in some embodiments.

FIG. 9 illustrates a process used to provision a mobile station using the access point in some embodiments.

FIG. 10 illustrates a system used to provision a user's subsequent mobile station using any touchtone phone in some embodiments.

FIG. 11 illustrates a process used to provision a user's subsequent mobile station using any touchtone phone in some embodiments.

FIG. 12 illustrates a system used to provision a user's subsequent mobile station at point of sale in some embodiments.

FIG. 13 illustrates a process used to provision a user's subsequent mobile station at point of sale in some embodiments.

FIG. 14 illustrates a system used to provision a user's subsequent mobile station using the user's previously provisioned mobile station in some embodiments.

FIG. 15 illustrates a process used to provision a user's subsequent mobile station using the user's previously provisioned mobile station in some embodiments.

FIG. 16 illustrates a system used to provision a mobile station to access a hot spot in some embodiments.

FIG. 17 illustrates a process used to provision a mobile station to access a hot spot in some embodiments.

FIG. 18 conceptually illustrates a computer system with which some embodiments are implemented.

### DETAILED DESCRIPTION OF THE INVENTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method that sends information about a wireless communication system access point to a server. The method receives the access point information at the mobile station from the server. The method enables the mobile station to access the wireless communication system through the access point by using the access point information. In some embodiments, the access point information is sent from the server to the mobile station using a short message service (SMS) message. In some embodiments, the access point information includes the SSID and the MAC ID of the access point.

Several more detailed embodiments of the invention are described in sections below. Sections I describes the overall architecture of a system that integrates a licensed and an unlicensed wireless communication system. The discussion in Section I is followed by a discussion of a provisioning system that enables a mobile station to be provisioned to connect to an access point. Several examples of provisioning a user's first and subsequent mobile stations are provided. Next, Section III defines the abbreviations used in this application. Last, Section IV describes a computer system with which some embodiments are implemented.

### I. OVERALL SYSTEM

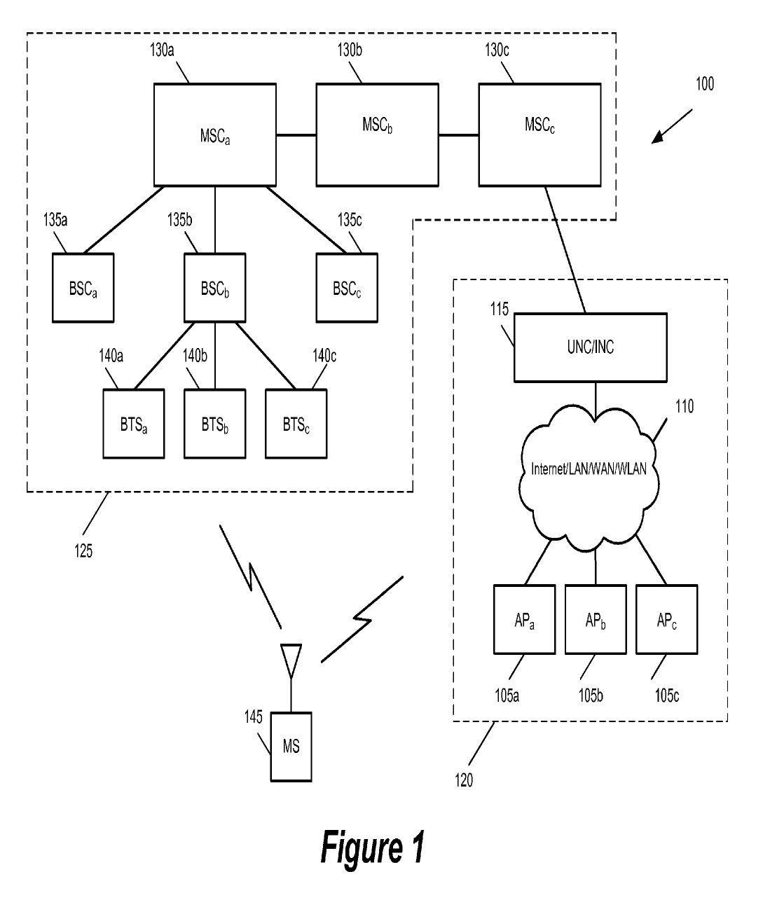

FIG. 1 illustrates the overall system architecture of some embodiments. Different components shown in the figure are described below. One or more access points (AP) 105a-105c, the intermediate private or public IP network 110, and the Unlicensed Mobile Access (UMA) Network Controller (UNC) 115, which includes an indoor network controller (INC), are together referred to as the unlicensed wireless communication system 120. In some embodiments, the IP network is a broadband network such as the Internet. In some embodiments, the UNC 115 and one or more APs 105a-105c are connected through broadband network circuits (e.g., DSL circuits, T1 circuits, E1 circuits, cable modem circuits, etc.)

A licensed wireless communication system 125 refers to a public cellular telephone systems and/or Personal Communication Services (PCS) telephone systems which provide service over a licensed frequency spectrum. Such licensed are expensive, as is the equipment used to support communications over these licensed frequencies, and this expense is passed to the user. An example of such a system is the Global System for Mobile Communication (GSM) Access Network, or GERAN. Other examples of such a system are Universal Mobile Telecommunication System (UMTS) and General Packet Radio Service (GPRS).

An unlicensed wireless communication system, on the other hand, may use a free spectrum (e.g., approximately 2.4 GHz or 5 GHz). Typically, the quality of service of a licensed wireless communication system is considerably inferior to the quality of service of an unlicensed wireless communication system. Thus, the user of a licensed wireless communication system pays relatively high fees for relatively low quality service.

FIG. 1 illustrates a system 100 that integrates a licensed wireless communication system 125 and an unlicensed wireless communication system 120. Such integrated wireless systems allow service to be provided through the unlicensed wireless communication system when the user is within an unlicensed wireless service coverage area. The user receives the benefit of relatively inexpensive, high quality communication service. If the user moves outside of the unlicensed wireless service coverage area, the same communication session can be maintained without interruption by transitioning to the licensed wireless communication system.

As shown in FIG. 1, the licensed wireless communication system 125 typically includes a number of mobile switching centers (MSCs) 130a-130c. Each MSC typically serves multiple base station controllers (BSCs) 135a-135c. Each BSC, in turn, serves multiple base station transceiver systems (BTSs) 140a-140c. A BSC and its associated BTSs are referred to as a base station subsystem (BSS).

The licensed wireless communication system 125 provides mobile wireless communications to individuals using wireless transceivers, shown for example as a mobile station (MS) 145. The MS is typically a handset device with dual mode GSM/UMA support where the unlicensed mode is provided using an IP over 802.11 (or similar) wireless local area network (WLAN) air interface. Also, some embodiments may support Bluetooth for the WLAN air interface. Mobile stations include cellular telephones, PCS telephones, wireless-enabled personal digital assistants, wireless modems, wireless mobile computers (laptops), and the like. A typical mobile station includes a display, keypad, and a control circuit. The display may provide a visual indication to a user when the mobile station is within the service range of the licensed or unlicensed wireless communication systems. The keypad is used in a conventional manner, and the control circuit may be in the form of a processor, a hardwired circuit, a programmable logic device, an application specific integrated circuit, and the like.

The mobile station also includes storage in the form of a machine-readable or computer-readable medium that includes computer program instructions for executing wireless protocols to manage communication sessions. Examples of machine-readable media or computer-readable media include, but not limited to magnetic media such as hard disks, memory modules, magnetic tape, optical media such as CD-ROMS and holographic devices, magneto-optical media such as optical disks, and hardware devices that are specially configured to store and execute program code, such as application specific integrated circuits (“ASICs”), programmable logic devices (“PLDs”), ROM, and RAM devices. Examples of computer programs or computer code include machine code, such as produced buy a compiler, and files containing higher-level code that are executed by a computer or a microprocessor using an interpreter.

As shown in FIG. 1, the unlicensed wireless communication system 120 is connected to the licensed wireless communication system 125 through the UNC 115. The UNC is connected to an MSC (e.g., MSC 130c) of the licensed wireless communication system. In some embodiments, the UNC simulates the functions of a BSC.

The UNC 115 is connected to one or more access points 105a-105c. The access points (also referred to as indoor base station or unlicensed base station) are standard, commercially available WLAN Access Point used to forward IP frames from the 802.11 (or Bluetooth) air interface into a public or private IP network 110.

### II. PROVISIONING SYSTEM

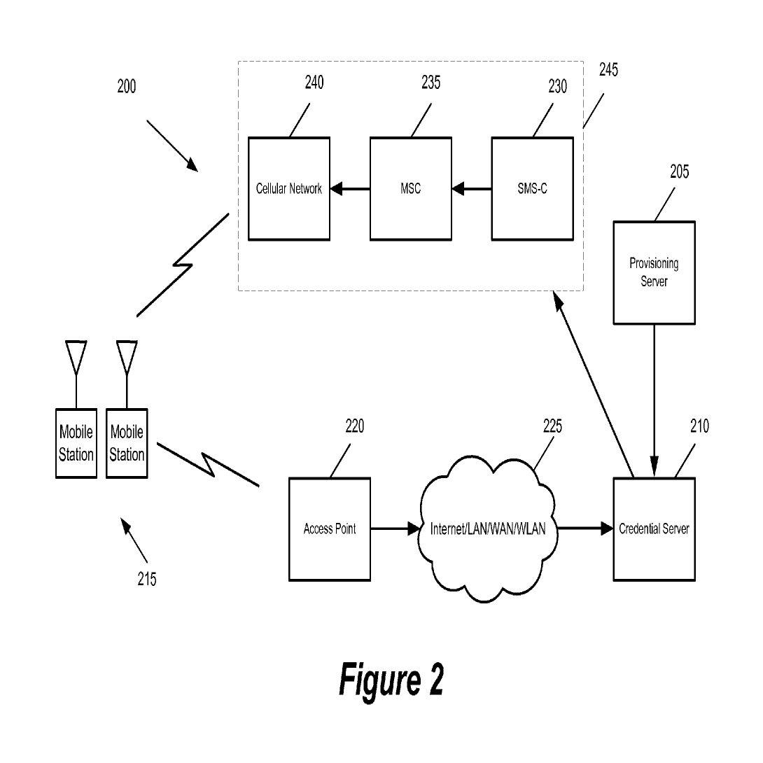

FIG. 2 illustrates different components of the communication system 200 used by a provisioning system of some embodiment. As described in the examples below, not all these components may be used in each scenario. The system 200 includes a provisioning server 205 and a credential server 210. In some embodiments, the provisioning server 205 is used at point of sale (POS) to provision different components of the unlicensed wireless communication system such as mobile stations and access points. In some embodiments, the provisioning server is a component of the licensed wireless communication system.

The credential server 210 is used in connection with the invention to provision the mobile stations to connect to the access points. In some embodiments, the credential server and the provisioning server are communicatively coupled through a broadband link (225) such as a LAN, WAN, WLAN, or the Internet. As shown, the credential server is also communicatively coupled to the licensed wireless communication system 245. In some embodiments, the credential server is communicatively coupled to the SMS-C through a broadband link (225) such as a LAN, WAN, WLAN, or the Internet. In other embodiments, the credential server is communicatively connected to the SMS-C through the other components of the licensed wireless communication system 245 such as the cellular network that includes a BSC and a BTS. In some embodiments, the credential server is a component of the unlicensed wireless communication system. In other embodiments, the credential server is a component of the licensed wireless communication system. Although the provisioning server and the credential server are shown as separate servers, a person of ordinary skill in the art would realize that the functionality of these servers can be merged into one server.

In some embodiments, the provisioning server and the credential server are used to provision mobile stations 215 to connect to an access point 220. In some embodiments, once a mobile station is provisioned, it can use the services of a wireless communication system, such as an unlicensed wireless communication system 120 through the access point. Also shown in FIG. 2 is a connection between the access point and the credential sever through a broadband link (225) such as a LAN, WAN, WLAN, or the Internet. As described below, this link is used in some embodiments to provision the mobile station through a phone connected to the access point.

Several components of a licensed wireless communication system are also shown in FIG. 2. These components are the Short Message Service Center (SMS-C) 230, MSC 235, and the cellular network (which includes BSS) 240. For simplicity, not all components of the licensed wireless communication system are shown in this figure. The SMS-C 230 is a component of the licensed wireless communication system which delivers Short Message Service (SMS) messages.

The SMS is a service available on digital mobile stations (such as cellular phones and other mobile stations that permits the sending of short messages (also known as text messages) between the mobile stations and even landline telephones. The term text messaging and its variants are more commonly used in North America and the UK, while most other countries use the term SMS. When a user sends or receives a text message (SMS message), the message gets stored in the SMS-C which delivers it to the intended destinations when they are available. In some embodiments, the credential server 210 is connected to the provisioning server 205 and SMS-C (230) through a broadband link such as a LAN, WAN, WLAN, or the Internet.

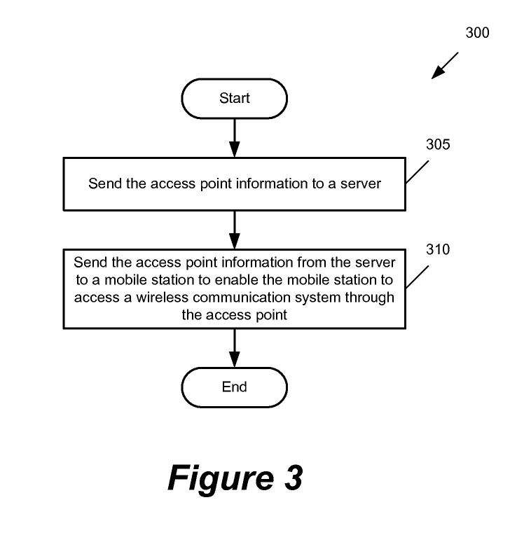

FIG. 3 illustrates a process 300 employed by some embodiments described below to provision a mobile station. The process sends (at 305) the access point information to a server. In some embodiments, this server is the credential server. In some embodiments, the access point information includes the access point attributes such as identification (e.g., the MAC ID) and the access point credentials (e.g., the SSID and a security key such as a WEP or a WAP key). Some embodiments send other information such as a location name (such as “Home” or “Office”) for the access point, a user selected personal identification number (PIN), and/or a mobile station identifier (such as Mobile Station International ISDN Number (MSISDN) or the International Mobile Subscriber Identity (IMSI) of the mobile station) to enable the mobile station to connect the access point. The MSISDN refers to a fixed number of digits that is used to refer to a particular mobile device. The IMSI is a unique number that is associated with all GSM and UMTS network mobile phone users. The number is stored in the Subscriber Identity Module (SIM) of the mobile station. Different embodiments send the above mentioned information to the server by different methods. For instance, some embodiments send the information through a broadband network such as a WAN/LAN/WLAN or the Internet. Some embodiments use a SMS message to send the information to the server.

The process then sends (at 310) the received information to the mobile station identified by the MSISDN. Some embodiments use a SMS message to send the information to the mobile station. The mobile station utilizes the received information to connect to the access point and to use the services of a communication system (such as an unlicensed wireless communication system) serviced by the access point.

Several examples of different embodiments for provisioning a mobile station are described in the following sub-sections by referring to the components of FIG. 2. A person of ordinary skill in the art would realize that the invention is not limited to the embodiments set forth and that the invention may be practiced without some of the specific details and examples discussed. Also, different features of each example can be combined by a person of ordinary skill in the art when provisioning a mobile station.

A. Provisioning a User's First Mobile Station

1. Provisioning Done at Point of Sale

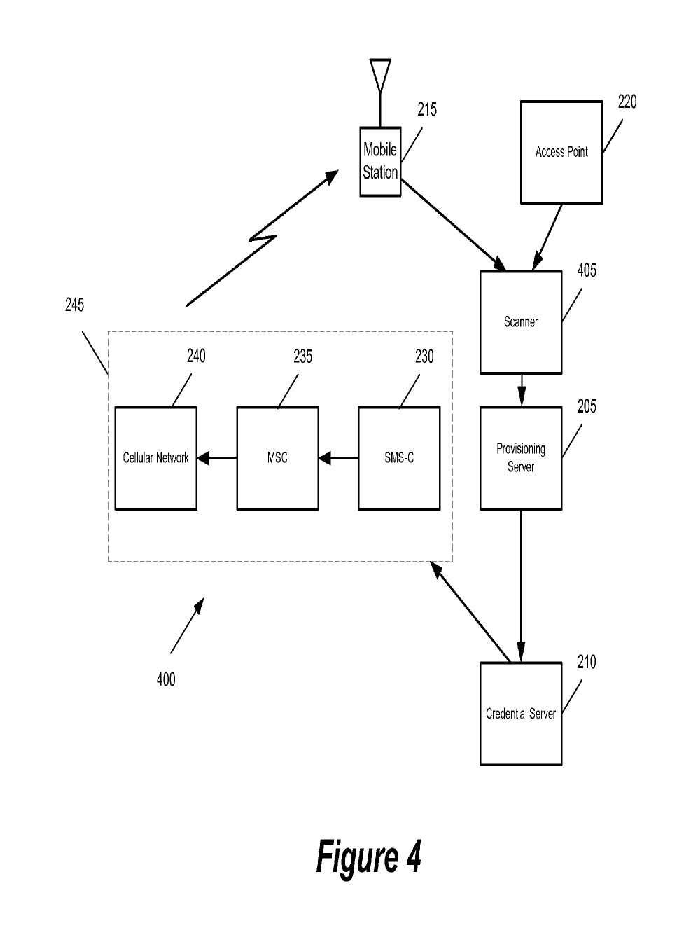

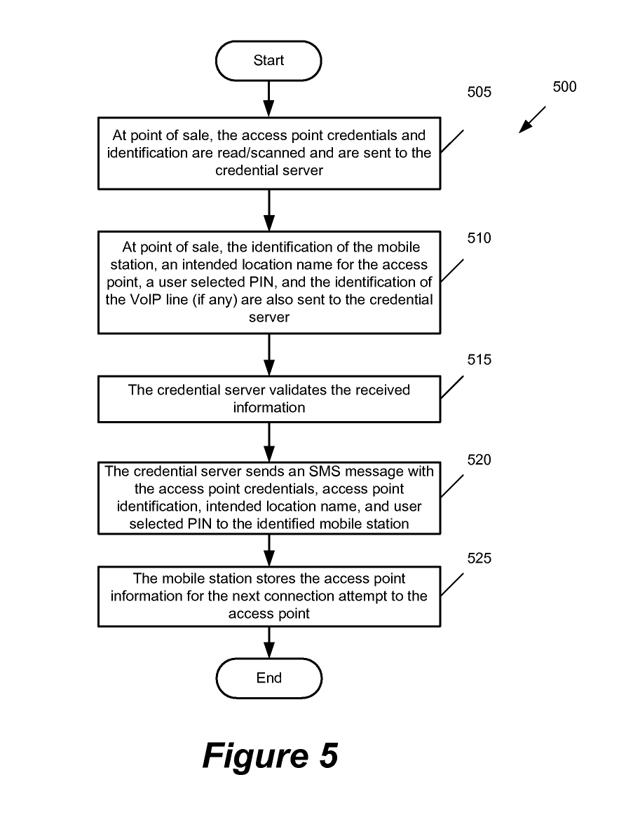

FIG. 4 illustrates a system 400 used to provision a user's first mobile station at the point of sale (POS) in some embodiments. This system is described in conjunction with process 500 illustrated in FIG. 5. Typically, the unlicensed service provider sells (or provides) an access point to a user who purchases a dual mode mobile station. In some embodiments, at POS, the access point credentials are already loaded in the access point. The access point credentials and MAC ID are typically read or scanned (at 505) from the access point package (e.g., using a bar code or a Radio Frequency Identification (RFID) tag) into the provisioning server.

In some embodiments a scanner 405 is used to scan the information. In other embodiments, the information is typed into a terminal (not shown) connected to the provisioning server. The provisioning server sends the scanned or entered information to the credential server.

Other information, such as the identification of the mobile station (e.g., the MSISDN), a location name for the access point, a user selected PIN, and the identification of a Voice over Internet Protocol (VoIP) line (if any) that will be connected to the access point are also entered (at 510) into the provisioning server terminal and are sent by the provisioning server to the credential server. In some embodiments, the identification of the VoIP line is the MSISDN of the VoIP line. In some embodiments, when a mobile station stores the VoIP line identification of an access point, the mobile station does not need a PIN to connect to the access point.

The credential server validates (at 515) the received information (e.g., user selected PIN number). Next (at 520), the credential server sends an SMS message to the mobile station identified by the MSISDN received from the provisioning server. The SMS message is in the form of a mobile terminated SMS (MT-SMS). The message includes the access point identification (e.g., MAC ID), credentials, location name, VoIP line identification as well as the user selected PIN. The mobile station stores (at 525) the received information for the next connection attempt to the access point.

2. Provisioning Done by the User Through the Mobile Station

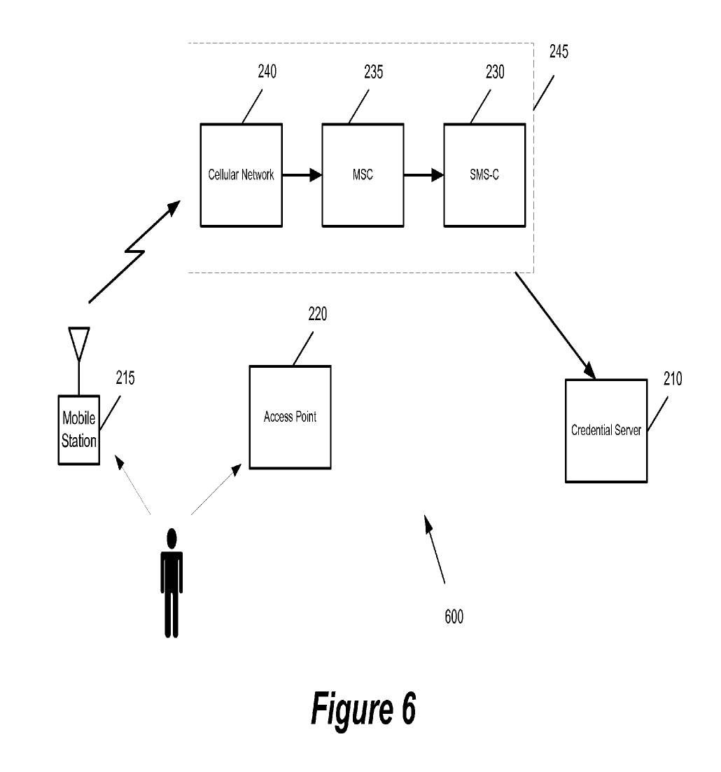

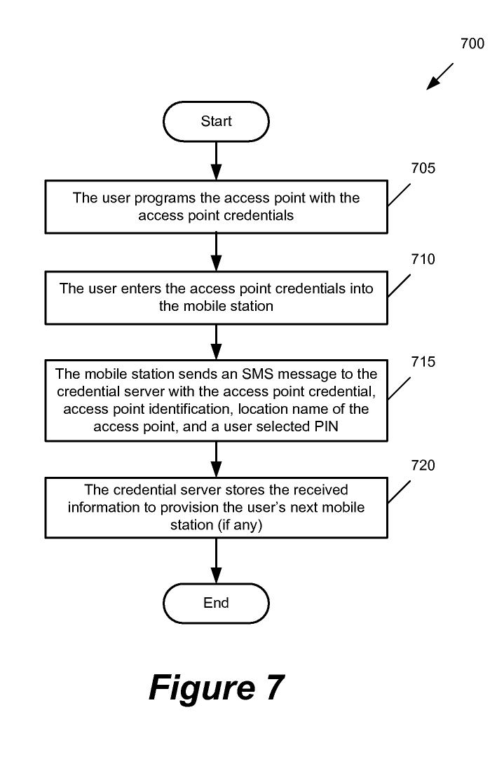

FIG. 6 illustrates a system 600 used to provision a user's first mobile station by the user through the mobile station. This system is described in conjunction with process 700 illustrated in FIG. 7. As shown in this figure, the user programs (at 705) the access point 220 with the access point credentials. The user also enters (at 710) the access point credentials into the mobile station 215.

At this point, both the access point and the mobile station are provisioned to connect to each other. Next, the mobile station sends (at 715) an SMS message to the credential server 210 with the access point identification, credentials, location name, a user selected PIN, and the identification of the access point's VoIP line (if any). The credential server 210 stores (at 720) this information to provision the user's subsequent mobile stations (if any).

3. Provisioning Done by the User Through the Access Point

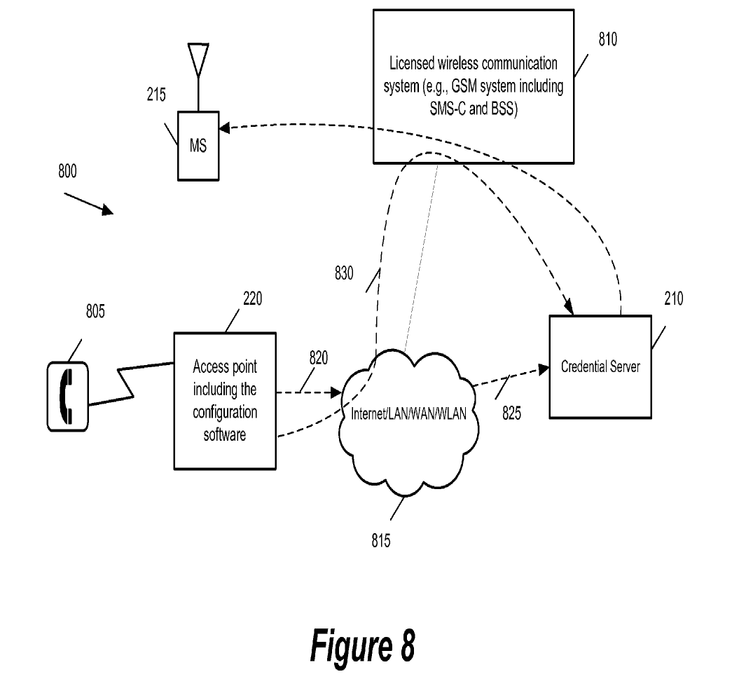

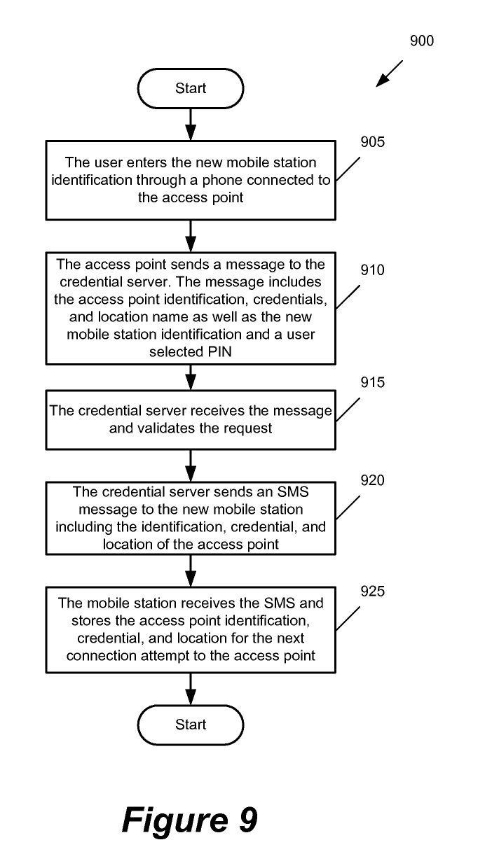

FIG. 8 illustrates a system 800 used to provision a user's first mobile station by the user through the access point. This system is described in conjunction with process 900 illustrated in FIG. 9. As shown in FIG. 9, the user enters (at 905) the mobile station 215 identification through a phone 805 connected to the access point. In some embodiments, this phone is a VoIP phone. The VoIP phone is a Plain Old Telephone System (POTS) telephone connected to the access point through a POTS port.

The access point 220 includes a configuration software that sends (at 910) a message to the credential server 210 that includes the identification, credentials, location name, and the VoIP line identification of the access point. In some embodiments, when the mobile station stores the VoIP line identification of an access point, the mobile station is considered a trusted device and does not require a PIN to connect to the access point. The credential server 210 receives (at 915) the message and validates the request. In some embodiments, the credential server 210 and the access point 220 are communicatively coupled through the broadband 815 (arrows 820 and 825). In these embodiments, the credential server and the access point can communicate using a common protocol. In other embodiments, the access point sends an SMS message to the credential server (arrow 830) through the SMS-C and the licensed wireless communication system 270.

The credential server 210 sends (at 920) a MT-SMS to the mobile station 215. The SMS includes the identification, credentials, location name, and the VoIP line identification of the access point. The mobile station receives (at 925) the SMS and stores the access point identification, credentials, location name, and VoIP line identification for the next connection attempt to the access point.

B. Provisioning the User's Subsequent Mobile Stations

1. Provisioning Done from any Touchtone Phone

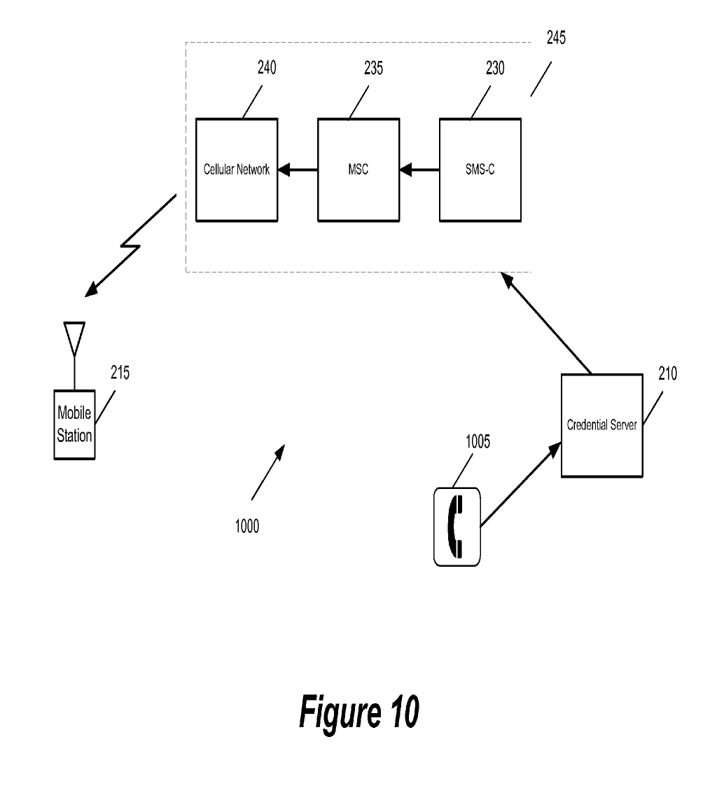

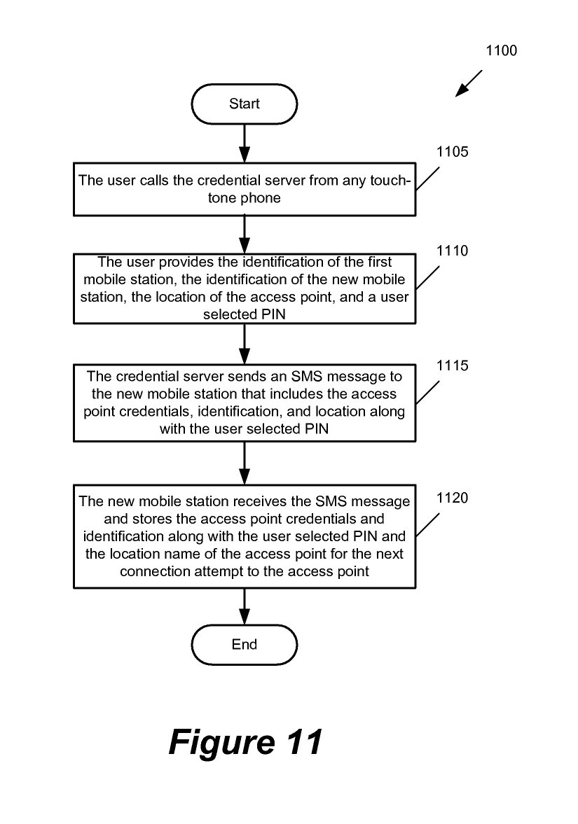

Once the first mobile station of a user is provisioned to use a certain access point, the user's subsequent mobile stations can be provisioned using the information already stored in the credential server. FIG. 10 illustrates a system 1000 that provisions a user's subsequent mobile stations through any touchtone phone in some embodiments. This system is described in conjunction with process 1100 illustrated in FIG. 11. As shown in FIG. 11, the user calls (at 1105) the credential server 210 from any touchtone phone (1005).

The user provides (at 1110) the identification of the first mobile station (not shown), the identification of the new mobile station 215, the location name of the access point 220, and the user selected PIN. In some embodiments, this PIN number is the same as the PIN selected for the first mobile station. The credential server 210 sends (at 1115) a MT-SMS message to the new mobile station 215. The SMS message includes the access point identification, credentials, and location along with the user selected PIN.

The new mobile station 215 receives (at 1120) the SMS message and stores the access point identification, credentials, location name, and VoIP line identification (if any) along with the user selected PIN for the next connection attempt to the access point 220.

2. Provisioning Done at Point of Sale

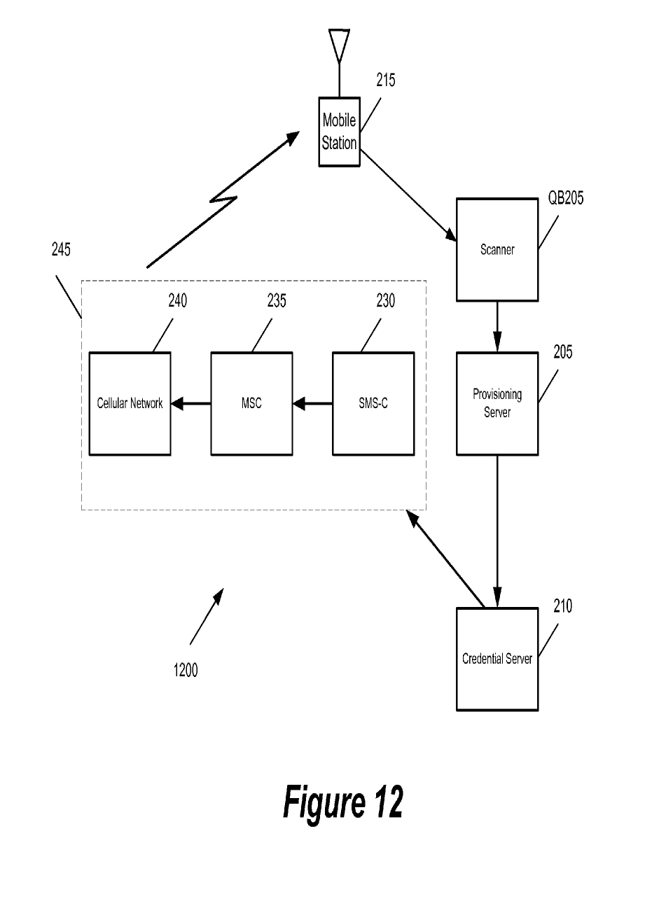

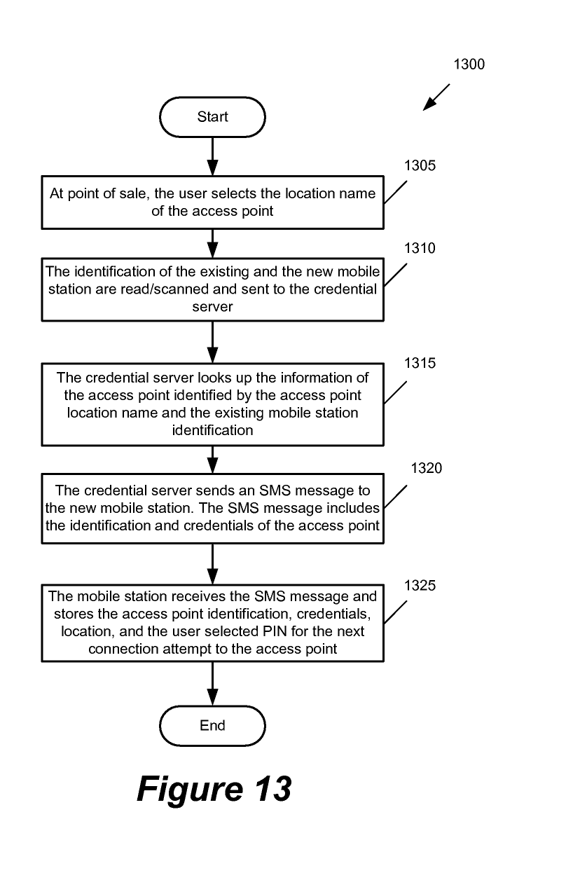

FIG. 12 illustrates a system 1200 that provisions a user's subsequent mobile station 215 at POS. This system is described in conjunction with process 1300 illustrated in FIG. 13. As shown in FIG. 13, at POS, the user selects (at 1305) the location name of the access point. In some embodiments, the identification of the access point is entered instead of the location name. The identification of the existing mobile station and the new mobile station are then scanned (at 1310) with the scanner 405 or manually entered into the provisioning server 205. In some embodiment, a user selected PIN is also entered into the provisioning server. The provisioning server sends the scanned and/or entered information to the credential server 210.

The credential server looks into a database (at 1315) and locates the access point information associated with the exiting mobile station and the received access point location name. The credential server sends (at 1320) a MT-SMS message to the new mobile station 215. The SMS message includes the identification, credentials, and location of the access point along with the user selected PIN. The mobile station 215 receives (at 1325) the SMS message and stores the access point identification, credentials, location name, and the user selected PIN for the next connection attempt to the access point 220.

3. Provisioning Done from a Previously Provisioned Mobile Station

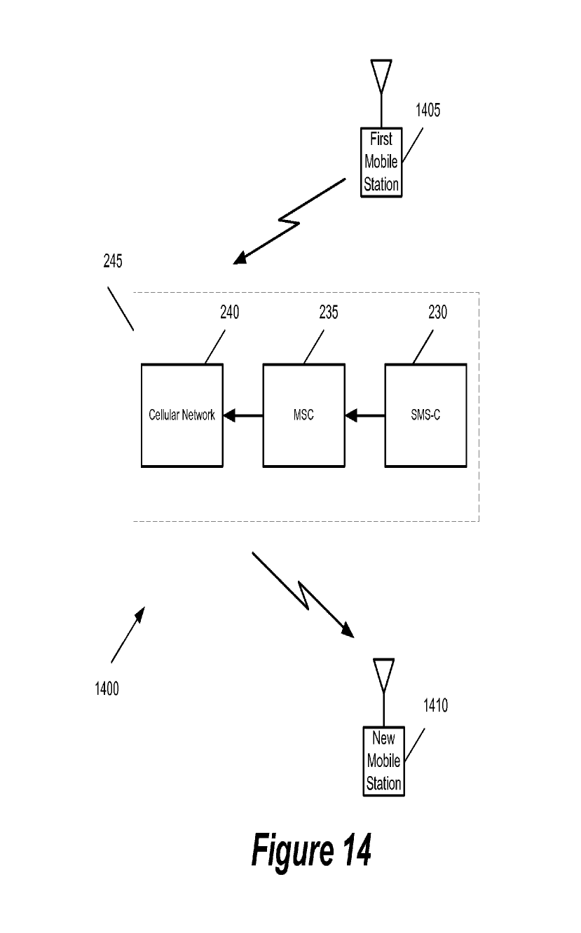

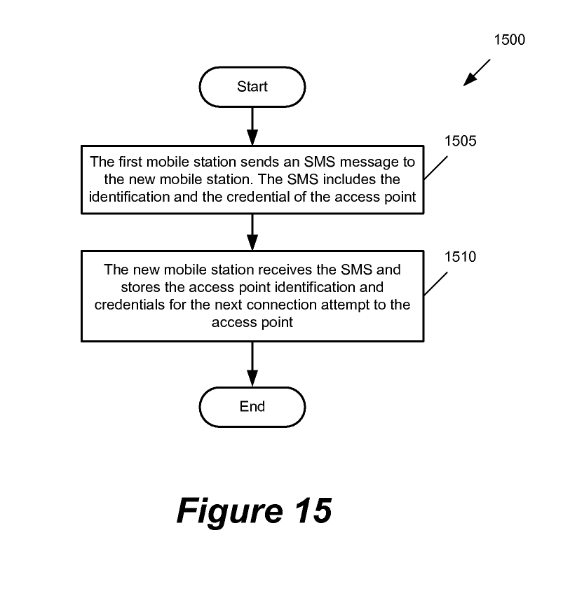

FIG. 14 illustrates a system 1400 that provisions a user's subsequent mobile station 215 through the user's previously provisioned mobile station. This system is described in conjunction with process 1500 illustrated in FIG. 15. As shown in FIG. 15, the first mobile station 1405 sends (at 1505) a mobile initiated SMS (MI-SMS) message to the new mobile station 1410 through the licensed wireless communication system 245 that includes the SMS-C. For simplicity, the individual components of the licensed wireless communication system are not shown in FIG. 14. The SMS message includes the identification, credentials, location name, and the VoIP line identification (if any) of the access point. In some embodiments, when a VoIP line identification is not available, the SMS message includes the user selected PIN.

The new mobile station 1410 receives (at 1510) the MI-SMS. The new mobile station 1410 stores the access point identification, credentials, location name, and the VoIP line identification of the access point for the next attempted connection to the access point 220.

4. Provisioning Done by the User Through the Access Point

The system and the process to provision a user's subsequent mobile station through the access point are similar to system 800 and process 900 described above in connection to the provisioning of the user's first mobile station.

C. Provisioning a Mobile Station to Use a Hotspot

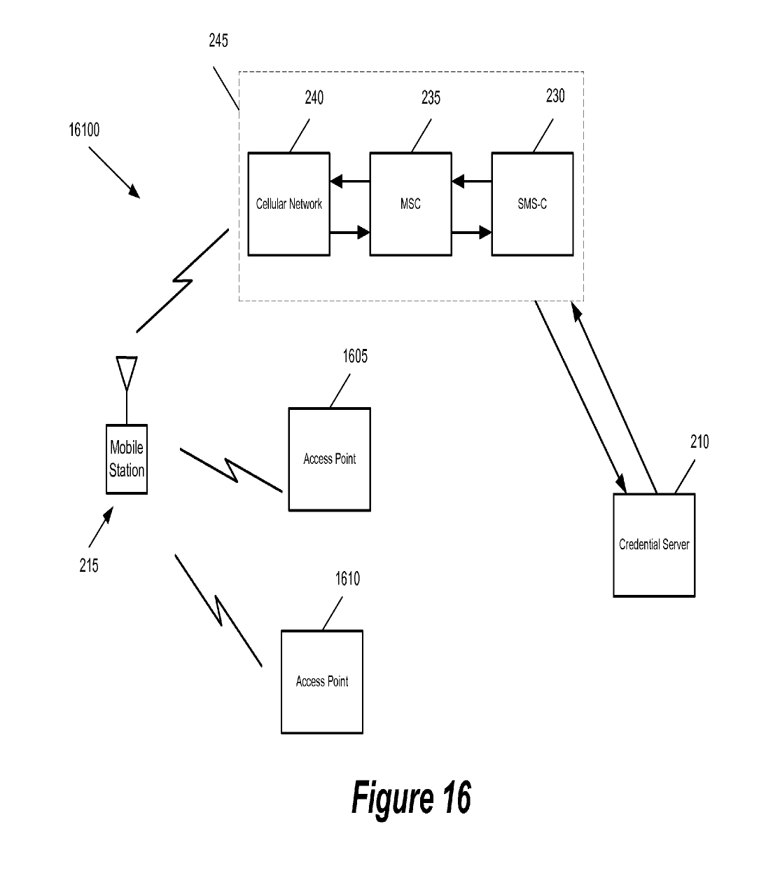

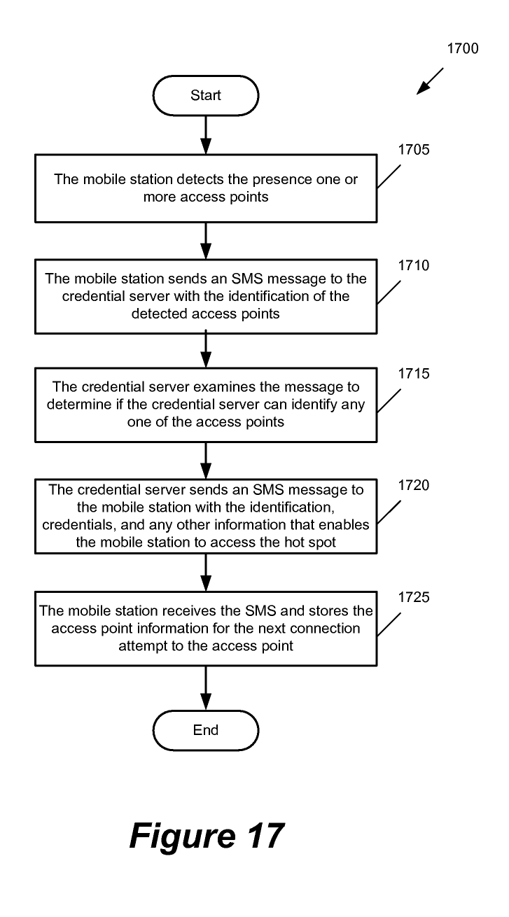

Often times, a mobile station user is away from home or office but is in a vicinity of a hot spot with a WiFi access point. FIG. 16 illustrates a system 1600 that provisions a mobile station 215 to access a hot spot. This system is described in conjunction with process 1700 illustrated in FIG. 17. As shown in FIG. 17, the mobile station 215 detects (at 1705) the presence of one or more access points 1605-1610. The mobile station sends (at 1710) a MO-SMS message to the credential server 210. The SMS message includes the identification (e.g., the MAC ID) of the access points.

The credential server examines (at 1715) the SMS to determine if it recognizes any of the access point. If the credential server recognizes one of the access points and determines that the mobile station is allowed to connect to the access point (e.g., the access point is a hot spot available for third parties to connect to), the credential server sends (at 1720) a MT-SMS message to the mobile station. The SMS message includes the identification, credential, and any other information that enables the mobile station to connect to the access point. The mobile station receives (at 1725) the SMS message and stores the received information for the next connection attempt to the access point

### III. DEFINITIONS AND ABBREVIATIONS

The following is a list of abbreviations used:

AP Access Point

### ASIC Application Specific Integrated Circuit

BSC Base station Controller

### BSS Base Station Subsystem

### BTS Base Transceiver Station

### CD-ROM Compact Disk Read-Only Memory

### GPRS General Packet Radio Service

### GSM Global System for Mobile Communication

### IMSI International Mobile Subscriber Identity

### INC Indoor Network Controller

### IP Internet Protocol

### ISDN Integrated Services Digital Network

### LAN Local Area Network

### MAC Media Access Control

### MO-SMS Mobile Originated SMS

### MS Mobile Station

### MSC Mobile Switching Center

### MSISDN Mobile Station International ISDN Number

MT-SMS Mobile terminated SMS

### PDA Personal Digital Assistant

### PIN Personal Identification Number

### PLD Programmable Logic Devices

### POTS Plain Old Telephone System

### RAM Random Access Memory

### ROM Read Only Memory

### SMS Short Message Service

### SMS-C SMS Controller

### SSID Service Set Identifier

### UMA Unlicensed Mobile Access

### UMAN UMA Network

### UMTS Universal Mobile Telecommunication System

### UNC UMA Network Controller

VoIP Voice over Internet Protocol

### WAN Wide Area Network

### WAP Wireless Application Protocol

### WEP Wired Equivalent Privacy

### WiFi Wireless Fidelity

### WLAN Wireless Local Area Network

### IV. COMPUTER SYSTEM

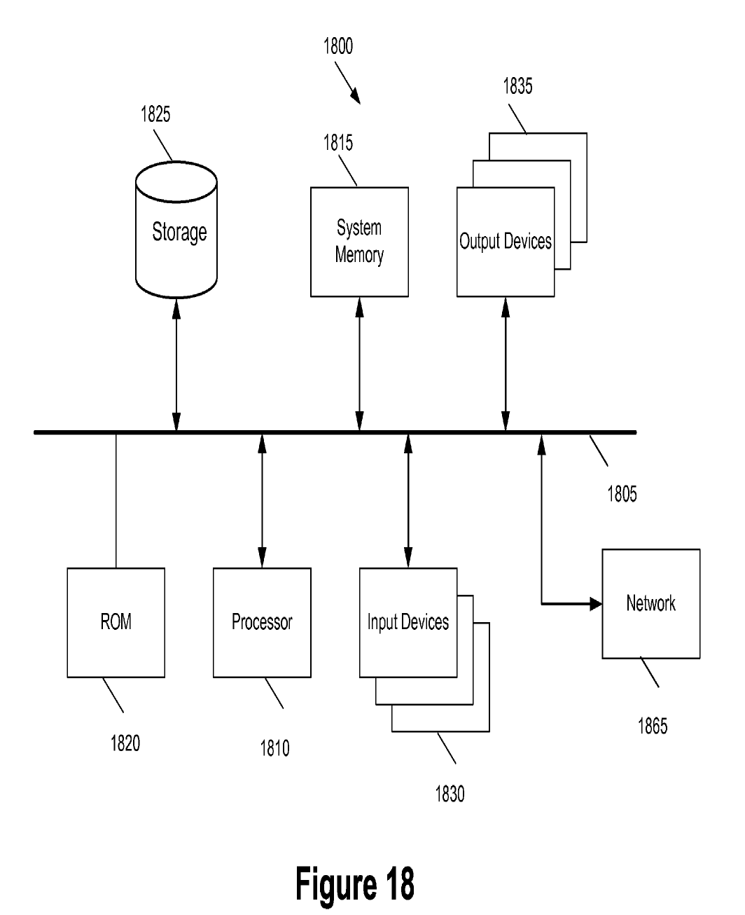

FIG. 18 conceptually illustrates a computer system with which some embodiments of the invention (for instance the credential server) are implemented. The computer system 1800 includes a bus 1805, a processor 1810, a system memory 1815, a read-only memory 1820, a permanent storage device 1825, input devices 1830, and output devices 1835.

The bus 1805 collectively represents all system, peripheral, and chipset buses that support communication among internal devices of the computer system 1800. For instance, the bus 1805 communicatively connects the processor 1810 with the read-only memory 1820, the system memory 1815, and the permanent storage device 1825.

From these various memory units, the processor 1810 retrieves instructions to execute and data to process in order to execute the processes of the invention. The read-only-memory (ROM) 1820 stores static data and instructions that are needed by the processor 1810 and other modules of the computer system. The permanent storage device 1825, on the other hand, is a read-and-write memory device. This device is a non-volatile memory unit that stores instruction and data even when the computer system 1800 is off. Some embodiments of the invention use a mass-storage device (such as a magnetic or optical disk and its corresponding disk drive) as the permanent storage device 1825. Some embodiments use one or more removable storage devices (flash memory card or memory stick) as the permanent storage device.

Like the permanent storage device 1825, the system memory 1815 is a read-and-write memory device. However, unlike storage device 1825, the system memory is a volatile read-and-write memory, such as a random access memory. The system memory stores some of the instructions and data that the processor needs at runtime.

Instructions and/or data needed to perform processes of some embodiments are stored in the system memory 1815, the permanent storage device 1825, the read-only memory 1820, or any combination of the three. For example, the various memory units may contain instructions for processing multimedia items in accordance with some embodiments. From these various memory units, the processor 1810 retrieves instructions to execute and data to process in order to execute the processes of some embodiments.

The bus 1805 also connects to the input and output devices 1830 and 1835. The input devices enable the user to communicate information and select commands to the computer system. The input devices 1830 include alphanumeric keyboards and cursor-controllers. The output devices 1835 display images generated by the computer system. For instance, these devices display IC design layouts. The output devices include printers and display devices, such as cathode ray tubes (CRT) or liquid crystal displays (LCD).

Finally, as shown in FIG. 18, bus 1805 also couples computer 1800 to a network 1865 through a network adapter (not shown). In this manner, the computer can be a part of a network of computers (such as a local area network (“LAN”), a wide area network (“WAN”), or an Intranet) or a network of networks (such as the Internet). Any or all of the components of computer system 1800 may be used in conjunction with the invention. However, one of ordinary skill in the art will appreciate that any other system configuration may also be used in conjunction with the invention.

While the invention has been described with reference to numerous specific details, one of ordinary skill in the art will recognize that the invention can be embodied in other specific forms without departing from the spirit of the invention. For instance, specific details of one or more examples can be combined to provision a mobile station. The MSISDN, IMSI, SSID, WEP, WAP, MAC ID, and the location name of the access point can be substituted with similar information to provision a mobile station. The disclosed techniques can be used for integrated system that includes licensed wireless communication systems other than GSM, GERAN, or GPRS or communication systems other than a UMAN. Also, the credential server can be part of either the licensed or unlicensed wireless communication systems. Also, in some embodiment, when an access point VoIP line identification is available and is e.g., stored in a mobile station, the mobile station does not require a PIN to connect to the access point.

In some examples and diagrams, two components may be described or shown as connected to each other. The connection may be a direct wire connection or the two components may be communicatively coupled to each other through other components or through wireless or broadband links. Thus, one of ordinary skill in the art would understand that the invention is not to be limited by the foregoing illustrative details, but rather is to be defined by the appended claims.

1-32. (canceled)

33. A method comprising:
a) calling a server from a touchtone phone;
b) through a touchtone keypad, entering an identification of a first mobile station previously provisioned to connect to a wireless communication system access point, an identification of a second mobile station not previously provisioned to connect to the access point;
c) receiving a short message service (SMS) message at the second mobile station from the server, the SMS comprising the access point identification and the access point credentials comprising a security key that enables the mobile station to communicatively couple to the access point.

34. The method of claim 33, wherein the SMS message further comprises a location name of the access point and one of a user selected personal identification number (PIN) and an identification of a voice over Internet Protocol (VoIP) line.

35. The method of claim 33, further comprising the second mobile station connecting to the access point utilizing the access point identification and the access point credentials.

36. A method comprising:
a) at a point of sale, sending an identification of a first mobile station, an identification of a second mobile station, and a location name of a wireless access point, the first mobile station previously provisioned to connect to a wireless communication system access point, the second mobile station not previously provisioned to connect to the access point to a server;
b) receiving a short message service (SMS) message at the second mobile station from the server, the SMS message comprising an identification and credentials of the access point; and
c) connecting to the access point by the second server using the identification and the credentials of the access point.

37. A method comprising:
a) sending a short message service (SMS) message from a first mobile station previously provisioned to connect to a wireless communication system access point to a second mobile station not yet provisioned to connect to the access point, the SMS message comprising identification and credentials of the access point, the access point credentials comprising a security key that enables the mobile station to communicatively couple to the access point; and
b) connecting to the access point by the second mobile station using the access point identification and the access point credentials.
